(19) United States
(12) Patent Application Publication
(10) Pub. No.: US 2026/0087674 A1
(43) Pub. Date: Mar. 26, 2026

(54) IMAGE PROCESSING APPARATUS, IMAGE PROCESSING METHOD, MEASUREMENT DEVICE, AND MEASUREMENT METHOD

(71) Applicant: CANON KABUSHIKI KAISHA, Tokyo (JP)

(72) Inventors: TAKAHISA AKAISHI, Kanagawa (JP); FUMITAKA GOTO, Tokyo (JP); AKITOSHI YAMADA, Kanagawa (JP); TOMOKAZU ISHIKAWA, Kanagawa (JP); YUTA IKESHIMA, Kanagawa (JP); YUJI AKIYAMA, Kanagawa (JP)

(21) Appl. No.: 19/336,186

(22) Filed: Sep. 22, 2025

(30) Foreign Application Priority Data
Sep. 26, 2024 (JP) 2024-167675

(51) Int. Cl. G06T 7/90; G01J 3/46; G06K 15/02; G06T 7/00

(52) U.S. Cl. CPC G06T 7/90; G01J 3/463; G06K 15/021; G06T 7/001; G06T 2207/10024; G06T 2207/30144

(57) ABSTRACT

Image processing apparatuses, image processing methods, measurement devices, measurement methods, and storage mediums are provided herein. One or more image processing apparatuses measure a patch on metallic paper using a measurement unit that measures only diffuse light in a specific direction by placing a diffusion sheet that converts a strong directional component of light into a diffuse component between the metallic paper and the measurement unit.

### BACKGROUND

### Field of the Technology

The present disclosure relates to one or more embodiments of an image processing apparatus, an image processing method, a measurement device, a measurement method, and a program for determining a correction value used to print on metallic paper with specular reflection by using a measuring instrument that measures diffuse light in a specific direction.

### Description of the Related Art

In commercial industrial printing, when viewing a printed subject on a printing medium, such as high-quality paper or coated paper, it is common to avoid the specularly reflected light. Therefore, measuring instruments with 0/45 or 45/0 optical geometry, which measure diffuse light from a specific direction, are generally and widely used. A variety of types of printing media are used in commercial industrial printing, and it is required to accurately control color even for a printing medium with different coloring characteristics. In response to the requirement, a method for measuring color patches printed on a variety of types of printing media and generating ICC (International Color Consortium) profiles is used.

One of the special printing media is metallic paper. Metallic paper is specularly reflective. That is, most of the light from the light source of a measuring instrument is specularly reflected, and diffuse light in directions other than the specularly reflected direction is small. Therefore, a measuring instrument with 45/0 or 0/45 optical geometry, which measures diffuse light in a specific direction, cannot accurately measure colors printed on metallic paper.

In general, an integrating sphere measuring instrument or a multi-angle measuring instrument is used to measure colors printed on metallic paper.

Japanese Patent Laid-Open No. 2019-4322 describes a technique for identifying the print conditions by using a multi-angle measuring instrument in a printing apparatus that prints an image using a metallic color material. This technique can increase the color reproducibility as compared with the case where only a measurement value obtained from a specific direction is used.

### SUMMARY

According to one or more aspects of the present disclosure, there is provided at least one embodiment of an image processing apparatus that may include a measurement unit that operates to measure a diffuse light in a specific direction, wherein the measurement unit measures a patch printed on a metallic paper that serves as a printing medium to be measured in a state in which a diffusion sheet that converts a strong directional component of light into a diffuse component is disposed between the metallic paper and the measurement unit; and a determination unit that operates to determine a correction value for printing an image on the metallic paper based on a color matching target value corresponding to the state and a measurement result of the patch measurement performed by the measurement unit.

According to other aspects of the present disclosure, one or more additional image processing apparatuses, one or more methods, one or more measurement devices, one or more measurement methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1A is a schematic illustration of at least one embodiment example of a measurement of high-quality paper using a measuring instrument with 45/0 optical geometry according to one or more aspects of the present disclosure.

FIG. 1B is a schematic illustration of at least one embodiment example of a measurement of metallic paper using a measuring instrument with 45/0 optical geometry according to one or more aspects of the present disclosure.

FIG. 2A is a schematic illustration of at least one embodiment example of a measurement using an integrating sphere measuring instrument according to one or more aspects of the present disclosure.

FIG. 2B is a schematic illustration of at least one embodiment example of a measurement using a multi-angle measuring instrument according to one or more aspects of the present disclosure.

FIG. 3 is a cross-sectional view of at least one embodiment example of an internal configuration of a printing apparatus according to one or more aspects of the present disclosure.

FIG. 4 is a configuration diagram of at least one embodiment example of a printing system according to one or more aspects of the present disclosure.

FIG. 5 illustrates one or more printing processes performed by at least one embodiment example of a printing system according to one or more aspects of the present disclosure.

FIG. 6 illustrates at least one embodiment example of a color matching setting screen according to one or more aspects of the present disclosure.

FIG. 7 is at least one embodiment example of a sequence diagram of color conversion performed in a conversion process according to one or more aspects of the present disclosure.

FIG. 8 illustrates information contained in at least one embodiment example of original document data according to one or more aspects of the present disclosure.

FIG. 9 illustrates at least one embodiment example of a color conversion flow for a spot color according to one or more aspects of the present disclosure.

FIG. 10 illustrates at least one embodiment example of information contained in a spot color library according to one or more aspects of the present disclosure.

FIG. 11A is an image diagram illustrating at least one embodiment example of an overview of a measurement unit according to one or more aspects of the present disclosure.

FIG. 11B illustrates a position of at least one embodiment example of a pressing mechanism in a case where metallic paper is measured according to one or more aspects of the present disclosure.

FIG. 11C illustrates a position of at least one embodiment example of a pressing mechanism in a case where a printing medium other than metallic paper is measured according to one or more aspects of the present disclosure.

FIG. 12A illustrates at least one embodiment example of an ICC profile creation dialog according to one or more aspects of the present disclosure.

FIG. 12B illustrates at least one embodiment example of a printing medium name list box according to one or more aspects of the present disclosure.

FIG. 12C illustrates at least one embodiment example of a printing medium type list box according to one or more aspects of the present disclosure.

FIG. 12D illustrates at least one embodiment example of a patch type list box according to one or more aspects of the present disclosure.

FIG. 13 is a flowchart of at least one embodiment example of an ICC profile creation according to one or more aspects of the present disclosure.

FIG. 14 illustrates experimental results for at least one embodiment example according to one or more aspects of the present disclosure.

FIG. 15A is a schematic illustration of at least one embodiment example of a distribution of measurement values when a clear film is used according to one or more aspects of the present disclosure.

FIG. 15B is a schematic illustration of at least one embodiment example of a distribution of measurement values when one-ply tracing paper is used according to one or more aspects of the present disclosure.

FIG. 15C is a schematic illustration of at least one embodiment example of a distribution of measurement values when one-ply translucent film is used according to one or more aspects of the present disclosure.

FIG. 15D is a schematic illustration of at least one embodiment example of a distribution of measurement values when a three-ply translucent film is used according to one or more aspects of the present disclosure.

FIG. 16A illustrates combinations that are checked in an experiment for at least one embodiment example according to one or more aspects of the present disclosure.

FIG. 16B illustrates the results of the experiment for at least one embodiment example according to one or more aspects of the present disclosure.

FIG. 17A illustrates at least one embodiment example of an overlap of color gamuts of first and second diffusion sheets according to one or more aspects of the present disclosure.

FIG. 17B illustrates at least one embodiment example of an overlap of color gamuts of first and second diffusion sheets according to one or more aspects of the present disclosure.

FIG. 18 illustrates at least one embodiment example of a spot color adjustment setting screen according to one or more aspects of the present disclosure.

FIG. 19 illustrates at least one embodiment example of a spot color adjustment flow according to one or more aspects of the present disclosure.

FIG. 20 illustrates at least one embodiment example of a message displayed when a metallic-type printing medium is measured according to one or more aspects of the present disclosure.

FIG. 21A illustrates at least one embodiment example of spot color adjustment patches according to one or more aspects of the present disclosure.

FIG. 21B illustrates at least one embodiment example of a Lab value of each of the spot color adjustment patches according to one or more aspects of the present disclosure.

FIG. 22 illustrates at least one embodiment example of a color reproduction of a color patch printed on metallic paper according to one or more aspects of the present disclosure.

FIG. 23 illustrates at least one embodiment example of a UI unit that displays a notification to a user according to one or more aspects of the present disclosure.

### DESCRIPTION OF THE EMBODIMENTS

Embodiments of the present disclosure are described below with reference to the accompanying drawings.

### Configuration(s) for One or More Embodiments

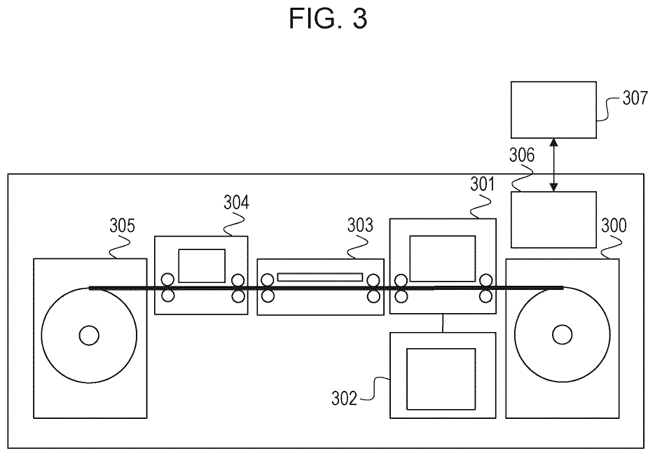

FIG. 3 is a cross-sectional view of at least one embodiment example of an internal configuration of a printing apparatus according to one or more aspects of the present disclosure. The printing apparatus according to one or more embodiments is an inkjet printing apparatus and is a line printer that performs so-called one-pass printing using a rolled continuous sheet as a printing medium. The term “one-pass printing” refers to a printing method in which a printing medium is conveyed relative to a fixed print head, and printing of an image is completed by a single relative scan between the print head and the printing medium. In contrast to the one-pass printing, multi-pass printing may be employed. Multi-pass printing is a printing method in which printing of an image is completed by multiple relative scans, such as multiple scans of the print head against the printing medium. At least one embodiment is described below with reference to a line printer that performs one-pass printing. However, the at least one embodiment is not limited thereto. A printer of a multi-pass printing type may be employed.

The printing apparatus includes a printing medium supply unit 300, a printing unit 301, an ink supply unit 302, a drying unit 303, a measurement unit 304, and a printing medium discharge unit 305. A printing medium is conveyed by a conveyance mechanism including roller pairs and belts disposed along a conveyance path (indicated by a thick solid line in FIG. 3) from the printing medium supply unit 300 to the printing medium discharge unit 305 and is processed by the above-described units.

The printing medium supply unit 300 is a unit that stores and supplies continuous printing medium rolled into a roll. The continuous printing medium is a paper-type, film-type, or metallic-type printing medium that may be inkjet-printed. The metallic-type printing medium supported by one or more embodiments is metallic paper for which the measurement results at any position in the non-printing area are almost the same, and metallic paper, such as a hologram, for which the measurement values vary in accordance with the position on the printing medium may not be supported by at least one embodiment.

The printing unit 301 is a unit for printing an image on a conveyed printing medium by using a print head. The printing unit 301 includes a plurality of conveyance rollers that convey the printing medium. The print head includes a row of nozzles each including a printing element for applying ink onto a printing medium. The print head according to one or more embodiments is a line-type print head with a nozzle row formed to cover the maximum width of printing media that are expected to be used, and a plurality of print heads are arranged in parallel along a conveyance direction. An example of an inkjet method to eject droplets of ink is a method using a heating element, a piezoelectric element, an electrostatic element, or a MEMS element as printing elements in the nozzles. The print head according to one or more embodiments may eject four colors of ink: cyan (C), magenta (M), yellow (Y), and black (BK). The ink is supplied from the ink supply unit 302 to the print head via an ink tube corresponding to one of the colors.

The drying unit 303 is a unit for heating the printing medium printed in the printing unit 301 and drying the ink applied onto the printing medium in a short time. The drying unit 303 includes a conveyance belt and conveyance rollers for feeding the printing medium to be subjected to the next process. The measurement unit 304 includes a measuring instrument with 0/45 optical geometry that automatically measures a color patch printed in the printing unit 301. The measurement unit 304 is described in more detail below.

The printing medium discharge unit 305 includes a take-up device that rolls dried printing medium and discharges the printing medium. A printing apparatus control unit 306 is a unit that controls various units of the printing apparatus. The printing apparatus control unit 306 includes a central processing unit (CPU), a memory, a controller with various I/O interfaces, and an electric power source. The operation performed by the printing apparatus is controlled based on an instruction received from the controller or an image processing apparatus 307, such as a host computer, that is connected to the controller via the I/O interface. At least one embodiment has been described with reference to the configuration in which the image processing apparatus 307 is located outside of the printing apparatus. However, the image processing apparatus 307 may be located inside of the printing apparatus.

### Configuration(s) of One or More Embodiments of a Printing System

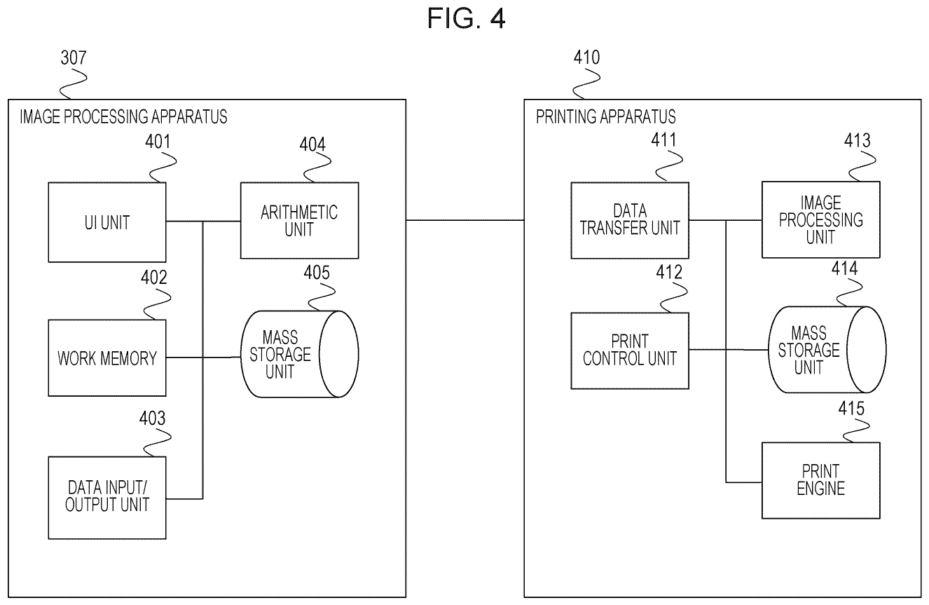

FIG. 4 illustrates the configuration of a printing system. The printing system according to one or more embodiments includes the image processing apparatus 307 and a printing apparatus 410. The image processing apparatus 307 performs a rasterization process and a color matching process, transfers a print instruction, information, and data required for image processing to the printing apparatus 410, and performs a conversion process to device-dependent color space. Data transfer to and from the printing apparatus 410 is performed via an interface, such as a network, a universal serial bus (USB), or a local bus. The image processing apparatus 307 includes a UI unit 401, a work memory 402, a data input/output unit 403, an arithmetic unit 404, and a mass storage unit 405.

The UI unit 401 is a user interface that receives, from a user, a variety of inputs including color settings and displays necessary information to a user. In general, the UI unit 401 includes an input device, such as a keyboard and a mouse, and an output device, such as a liquid crystal display. For example, the UI unit 401 may be a touch panel having both input and output functions. The work memory 402 is a memory that provides a work area to the arithmetic unit 404. An example of the work memory 402 is a random-access memory (RAM). The data input/output unit 403 is an interface for receiving a print job and transferring data to the printing apparatus 410.

The arithmetic unit 404 includes a CPU and a GPU (graphics processing unit). The arithmetic unit 404 uses the work memory 402 to execute the software in the mass storage unit 405. The arithmetic unit 404 instructs the various units of the image processing apparatus 307 to execute each of steps of the process described below. Thus, the image processing according to one or more embodiments is performed. Examples of the mass storage unit 405 include a hard disk drive (HDD) and solid-state drive (SSD). The mass storage unit 405 stores data, such as a variety of setting values and parameters, necessary for various processes, in addition to software, such as an operating system (OS) and system programs.

The printing apparatus 410 includes a data transfer unit 411, a print control unit 412, an image processing unit 413, a mass storage unit 414, and a print engine 415. A print job output from the image processing apparatus 307 is received by the data transfer unit 411. The print job includes color-matched device CMYK data and print setting information. The data transfer unit 411 sends the device CMYK data in the received print job to the image processing unit 413 and sends the print setting information in the received print job to the print control unit 412. The print control unit 412 controls the operation performed by the print engine 415 based on the print setting information.

The print engine 415 includes a print head that ejects ink and a supply system that supplies ink to the print head. The print engine 415 performs an ink ejection operation based on image data after a series of image processes performed by the image processing unit 413 (described below).

### Sequence(s) of One or More Embodiments of a Printing System

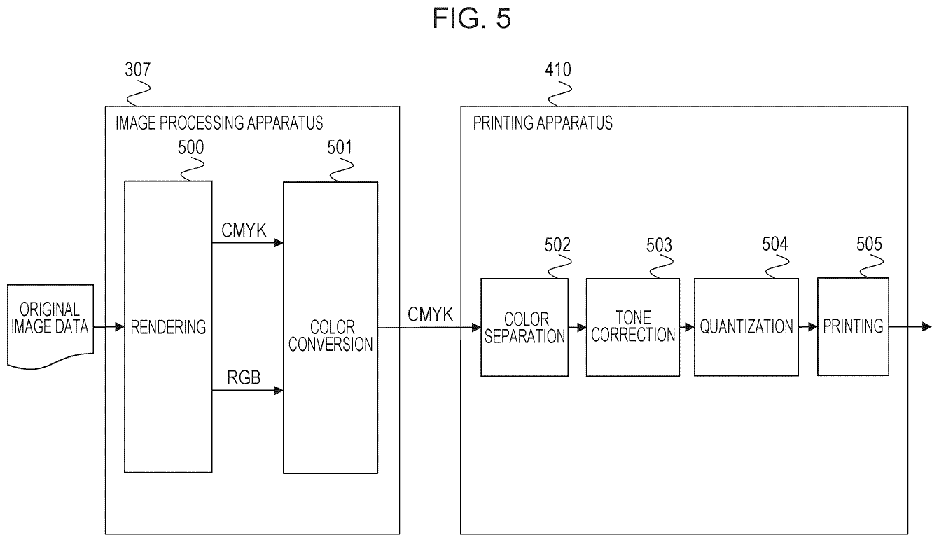

FIG. 5 illustrates a printing process flow performed by one or more embodiments of the printing system. Original image data input to the image processing apparatus 307 is RGB data specified using RGB luminance signal values or CMYK data specified using CMYK ink usage. The file format of the original image corresponds to at least Portable Document Format (hereinafter referred to as “PDF”), but is not limited thereto.

In a rendering process 500, the arithmetic unit 404 renders the original image data.

In a color conversion process 501 subsequent to the rendering process performed on the original image data, the arithmetic unit 404 color-converts the image signal values of a target object in the original image data.

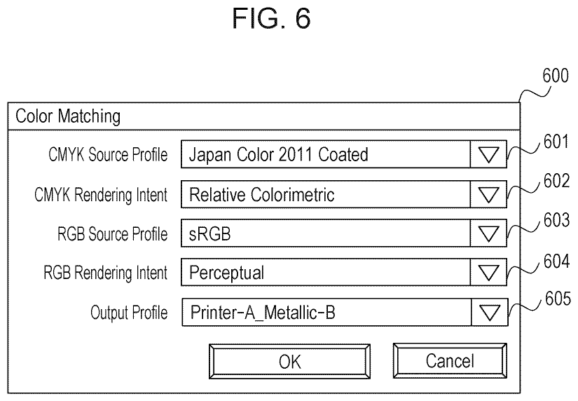

In the color conversion process 501, the arithmetic unit 404 performs color conversion of CMYK and RGB data using the conversion parameters in the mass storage unit 405 based on the color conversion information set in the UI unit 401. The color conversion is color conversion using an ICC profile. The user sets the color conversion information in the UI unit 401 via a color matching setting screen 600 illustrated in FIG. 6. In the color matching setting screen 600, an output profile 605 is set for each of a CMYK source profile 601, a CMYK rendering intent 602, an RGB source profile 603, an RGB rendering intent 604.

The output profile is an ICC profile for outputting a CMYK value and is used to output CMYK data in the color conversion process 501. The flow to generate the output profile for each of the printing media used herein is described below. The output CMYK data is sent to the printing apparatus 410.

In a color separation process 502, the image processing unit 413 converts the CMYK data received from the image processing apparatus 307 into C, M, Y, and K signal values corresponding to C, M, Y, and K inks, respectively, used by the printing apparatus 410. At this time, the image processing unit 413 refers to a 4-dimensional look-up table (hereinafter referred to as an “LUT”) prestored in the mass storage unit 414 and converts the C, M, Y, and K signal values to the C, M, Y, and K signal values corresponding to the input C, M, Y, and K signal values in the LUT. The image processing unit 413 then uses the C, M, Y, and K signal values, which are the output values obtained in the color separation process 502, in a tone correction process 503.

In the tone correction process 503, the image processing unit 413 performs a primary transformation for each of the ink colors so that the density of the color represented on a sheet maintains a linear relationship with the input signal value in a case where the correction target is CMYK data. At this time, the image processing unit 413 refers to a one-dimensional LUT for each of the ink colors that is prestored in the mass storage unit 414.

In a quantization process 504, the image processing unit 413 converts the tone-corrected multi valued data into binary data in which “1” indicates ejection of an ink droplet (dot) and “0” indicates non-ejection for each of the ink colors. In a printing process 505, the print engine 415 controls the ink ejection operation from the print head based on the binary data.

### Sequence of One or More Embodiments of a Color Conversion

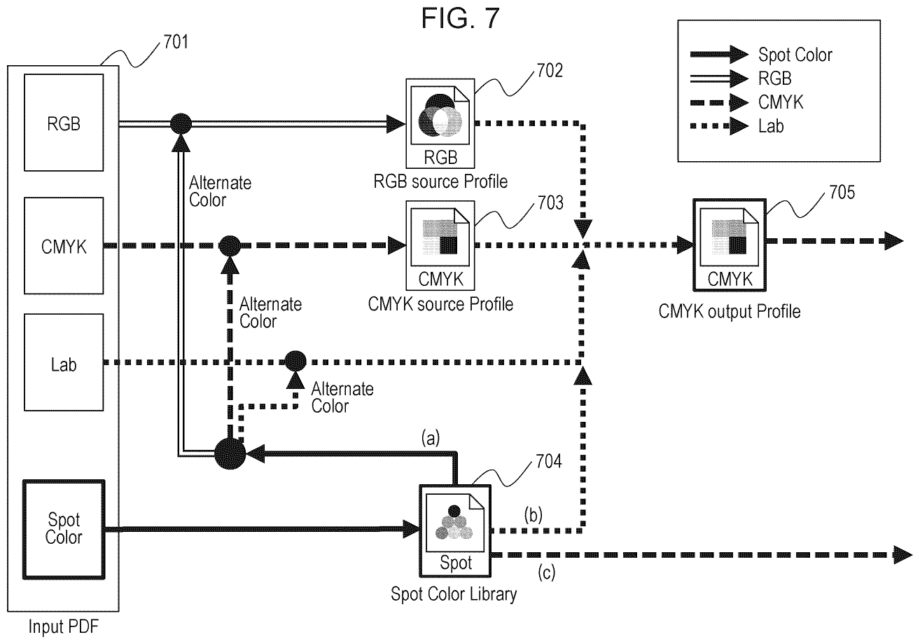

FIG. 7 illustrates the sequence of color conversion in the color conversion process 501. Original document data (Input_PDF) 701 is an original document to be printed on metallic paper.

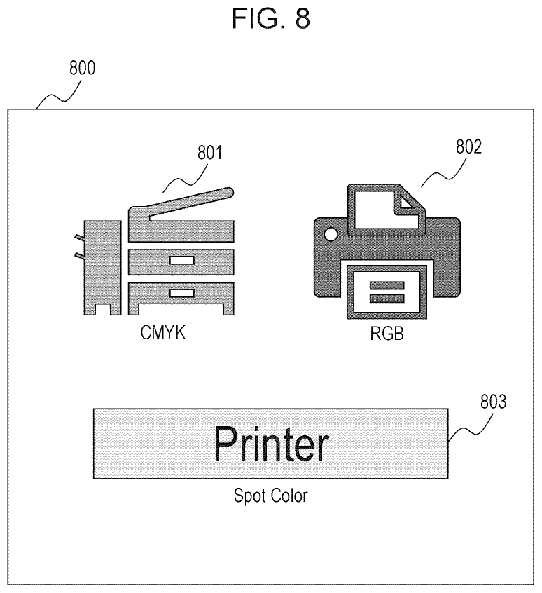

FIG. 8 illustrates original document data 800 to be printed on metallic paper. The original document data 800 is generated in a PDF file format. The original document data 800 includes a CMYK object 801 in a CMYK data format, an RGB object 802 in an RGB data format, and a spot color object 803 having a color specified as spot color data. The spot color data includes the name of the spot color, the color space of the alternate color, the value of the alternate color, and the Tint value (0 to 100%).

In Input_PDF 701, the RGB object 802 is converted to Lab data by an RGB source profile 702 and is converted to device CMYK data by a CMYK output profile 705. Similarly, the CMYK object 801 is converted to Lab data by a CMYK source profile 703 and is converted to device CMYK data by the CMYK output profile 705. The spot color object 803 is color-converted using a spot color library 704, which is prestored in mass storage unit 405.

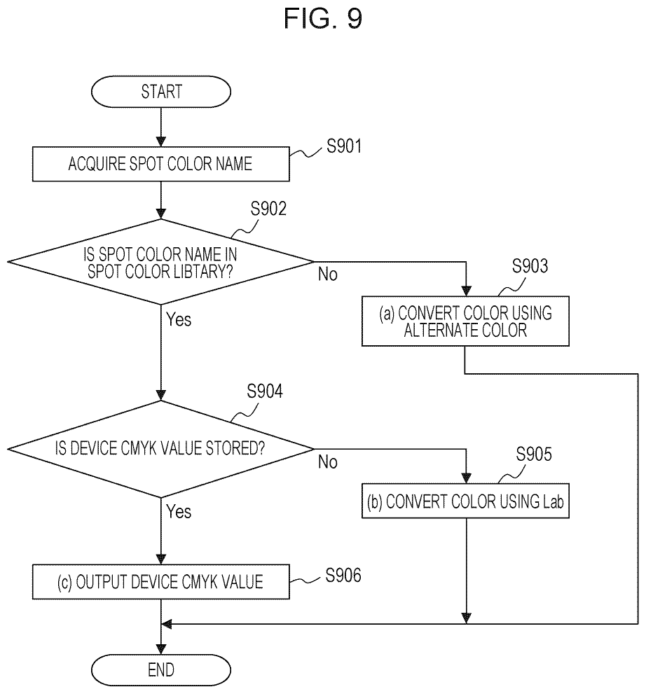

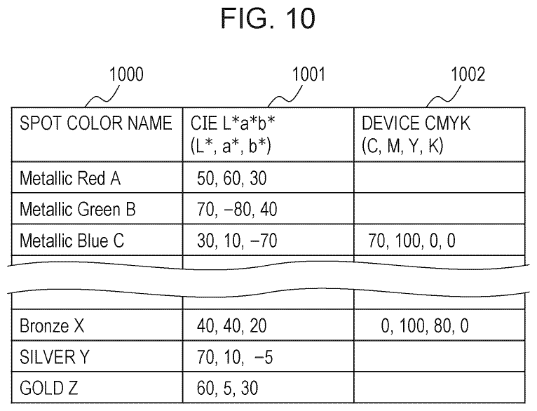

FIG. 9 illustrates the color conversion flow for a spot color. In step S901, a spot color name is acquired. In step S902, the acquired spot color name is searched for to determine whether the spot color name is stored in the spot color library 704. FIG. 10 illustrates the spot color library 704, which is a table storing information as illustrated. CIE-L*a*b* 1001 and device CMYK 1002 for a spot color name 1000 are stored in the table. For each of the registered spot color names, CIE-L*a*b* 1001, which is a color matching target value, is invariably registered. However, device CMYK 1002 is not invariably registered. If the user has adjusted the spot color to obtain the optimal CMYK value, the CMYK data is stored.

In step S902, the spot color name acquired in step S901 is searched for in the spot color names 1000. If there is no match, the processing proceeds to step S903. If there is a match, the processing proceeds to step S904. In step S903, a process (a): color conversion using an alternate color is performed in which colors are color-converted into the colors in the color space of the alternate color of the spot color.

In step S904, it is determined whether device CMYK 1002 of the spot color name that matches one of the spot color names 1000 stores data. If device CMYK stores no data, the processing proceeds to step S905. If device CMYK stores data, the processing proceeds to step S906. In step S905, a process (b): color conversion using Lab is performed in which colors are color-converted into Lab data. In step S906, a process (c) to output the stored device CMYK values is performed in which the stored device CMYK values are directly output without performing conversion by output profile.

### Details of One or More Embodiments of a Measurement Unit

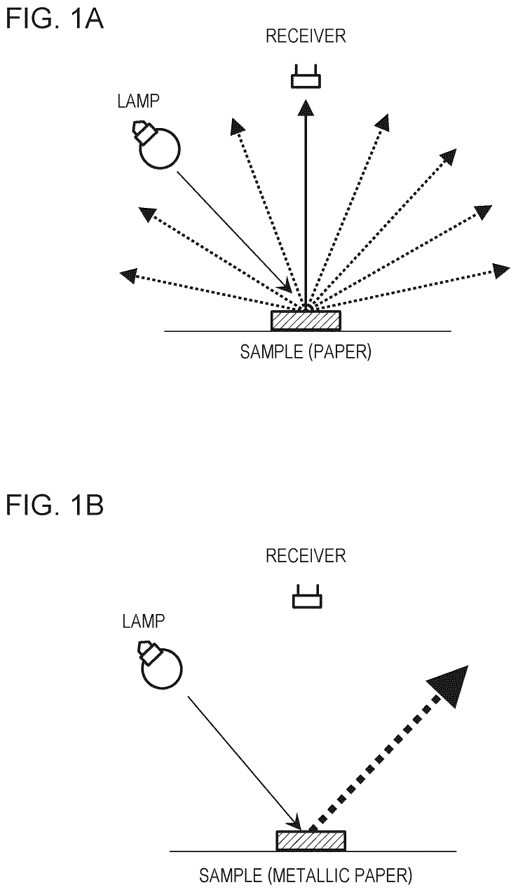

FIGS. 1A and 1B are schematic illustrations of measurement using a measuring instrument with 45/0 optical geometry. FIG. 1A illustrates the measurement of high-quality paper, one of printing media to be measured. Light is emitted from a light source in a direction of 45 degrees and is reflected by a surface of the high-quality paper to be measured. Because the surface of high-quality paper has very fine irregularities, the reflected light reflects not in one direction but in various directions (diffuses). A sensor receives and measures the reflected light diffused in a direction of 0 degrees.

FIG. 1B illustrates the measurement of metallic paper to be measured. The surface of metallic paper is like a mirror, and light emitted from a light source in a direction of 45 degrees is reflected mostly in the specularly reflected direction. The reflected light is not diffused in the 0-degree sensor direction. Therefore, in a case where the non-printing area of the metallic paper is measured using a measuring instrument with 45/0 or 0/45 optical geometry, the measurement value indicates that the non-printing area is very dark and, thus, an accurate measurement value may not be obtained.

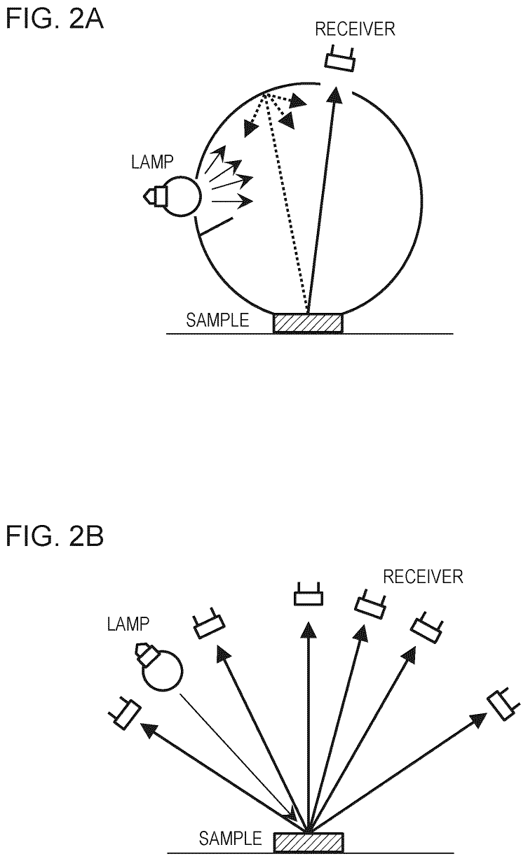

To accurately measure metallic paper, an integrating sphere measuring instrument or a multi-angle measuring instrument may be used, as illustrated in FIGS. 2A and 2B. FIG. 2A is a schematic illustration of measurement using an integrating sphere measuring instrument, which uses an integrating sphere or the like to evenly illuminate the measurement target from all directions. FIG. 2B is a schematic illustration of measurement using a multi-angle measuring instrument, in which the light source illuminates the measurement target in a direction of 45 degrees, and the sensor receives light at multiple reflection angles. A measuring instrument like the one illustrated in FIG. 2A or 2B may measure diffuse light rays having reflection intensities different at different angles, which is specific to metallic paper. The measurement unit 304 according to one or more embodiments will now be described in detail.

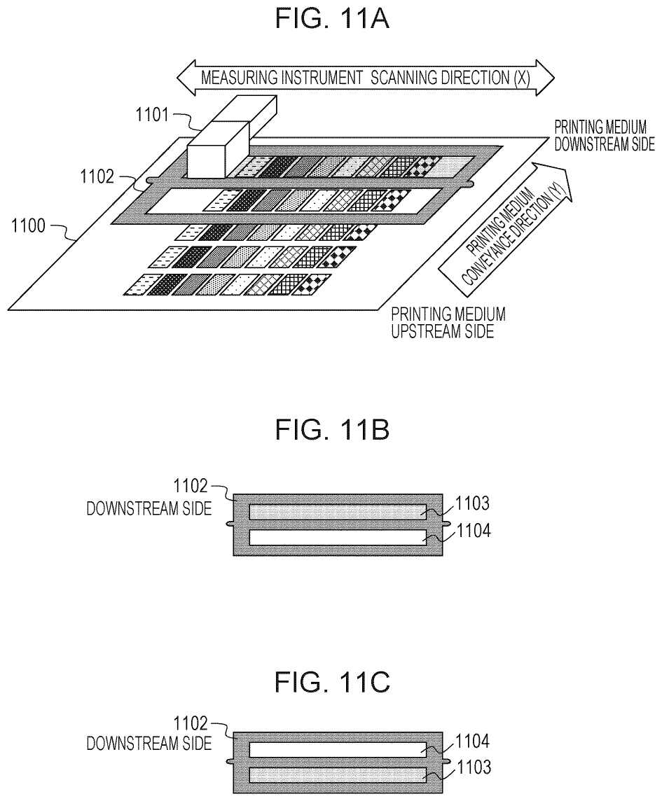

FIG. 11A is an image diagram illustrating an overview of the measurement unit 304. In FIG. 11A, a state 1100 is illustrated in which a continuous printing medium having a color patch for measurement printed thereon is conveyed to the measurement unit in the printing unit 301. A measuring instrument 1101 is a measuring instrument with 45/0 optical geometry that can measure diffuse light in a specific direction. The measuring instrument 1101 measures the color patch and obtains CIE L*a*b* values. The measuring instrument 1101 has a mechanism for scanning in a direction (the X direction in FIG. 11A) perpendicular to the direction (the Y direction in FIG. 11A) in which the printing medium is conveyed and, thus, may measure the color patch during scanning. A pressing mechanism 1102 is a mechanism that presses the printing medium. Immediately after the color patch is printed in the printing unit 301, the ink on the printing medium contains a lot of moisture. Therefore, the moisture in the ink is evaporated in the drying unit 303. However, since the moisture may not be completely eliminated, cockling may occur, depending on the type of printing medium. As a result, a surface having irregularities may be formed. The measuring instrument is designed on the condition that the distance from the sensor to an object to be measured is within a predetermined range. If irregularities are generated due to cockling, the distance from the sensor to the object to be measured varies, making it difficult to measure correctly. Therefore, the irregularities due to cockling are flattened by pressing the printing medium using the pressing mechanism.

As illustrated in FIGS. 11A to 11C, the pressing mechanism 1102 has two windows for measurement.

A measurement window 1103 is used to measure metallic paper, and a diffusion sheet is attached to the measurement window 1103 to convert the strong directional component of light into a diffuse component. A measurement window 1104 is used to measure a printing medium other than metallic paper, and no diffusion sheet is attached to the measurement window 1104.

According to one or more embodiments, of the two measurement windows 1103 and 1104, the measurement window located on the downstream side in the conveyance direction of the pressing mechanism 1102 (the upper window in FIGS. 11A to 11C) is used for measurement. The pressing mechanism 1102 according to one or more embodiments includes a mechanism (or a switching mechanism) to switch the position of the measurement window. FIG. 11B illustrates the placement of the measurement window in a case where metallic paper is measured, and FIG. 11C illustrates the placement of the measurement window in a case where a printing medium other than metallic paper is measured. The detailed description of the mechanism for switching between the states of FIG. 11B and FIG. 11C is omitted, but the mechanism is such that, for example, the positions of the measurement window 1103 having the diffusion sheet attached thereon and the measurement window 1104 having no diffusion sheet attached thereon are switched by rotating the pressing mechanism 1102 180 degrees.

In a case where the printing medium is conveyed, the pressing mechanism 1102 stands by while being separated from the printing medium. In a case where the conveyance stops for measurement, the pressing mechanism 1102 presses the printing medium and measures a color patch row on the printing medium while the measuring instrument scans in the scanning direction. In a case where the measurement of the color patch row to be measured is completed, the pressing mechanism 1102 is separated from the printing medium. In a case where the printing medium is intermittently fed to a position where the next color patch row can be measured, the next measurement operation starts.

### Creation of Spot Color Library Dedicated to Metallic Paper for One or More Embodiments

Creation of a spot color library dedicated to metallic paper is described below. In a case where performing color conversion for metallic paper, it may be preferred to use a spot color library dedicated to metallic paper in one or more embodiments. Using the same measuring instrument and diffusion sheet as in the measurement unit 304, a metallic color chart to be used for the spot color library is measured in advance and is stored in CIE-L*a*b* 1001 of the spot color library illustrated in FIG. 10 to create the library. In a case where the spot color library is first created, device CMYK 1002 is left unset in one or more embodiments.

### ICC Profile Generation Flow for One or More Embodiments

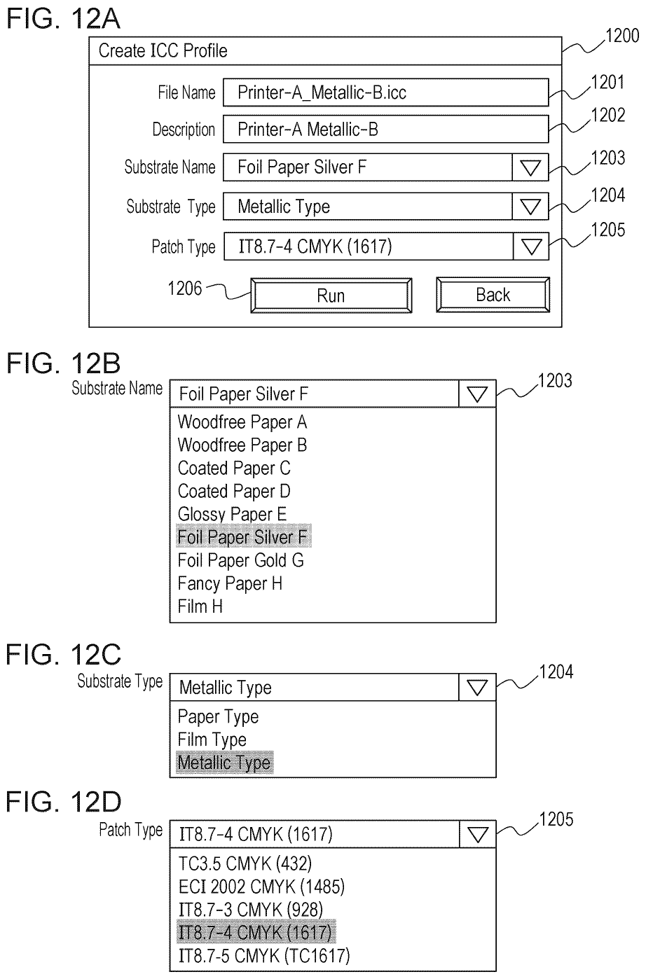

FIGS. 12A to 12D illustrate an ICC profile creation dialog 1200. The image processing apparatus 307 has a function to create an ICC profile for each of the types of printing media. In a case where the ICC profile creation function is activated via the UI unit 401, the ICC profile creation dialog 1200 is activated. A file name edit box 1201 is used to input the file name of the ICC profile to be created. The created ICC profile is stored in a predetermined folder as a file having the input file name.

Using a description edit box 1202, a profile description is input that is to be stored in the description tag of the ICC profile. The profile description is to be displayed during selection of the output profile 605 illustrated in FIG. 6. The name of the printing medium is selected using a printing medium name list box 1203. As illustrated in FIG. 12B, the names of printing media registered through the function of registering a printing medium (not illustrated) are displayed, and the selected one of the printing medium names is displayed.

The type of printing medium is selected using a printing medium type list box 1204. The type of the printing medium selected from the printing medium name list box 1203 (the printing medium type) is selected from the types of printing media listed in FIG. 12C. The following three printing medium types are available: a paper type, a film type, and a metallic type. In a case where metallic paper is used, the metallic type is selected.

Using a patch type list box 1205, the type of patch to be used in ICC profile creation is selected. The type of patch is selected from the types of patches illustrated in FIG. 12D.

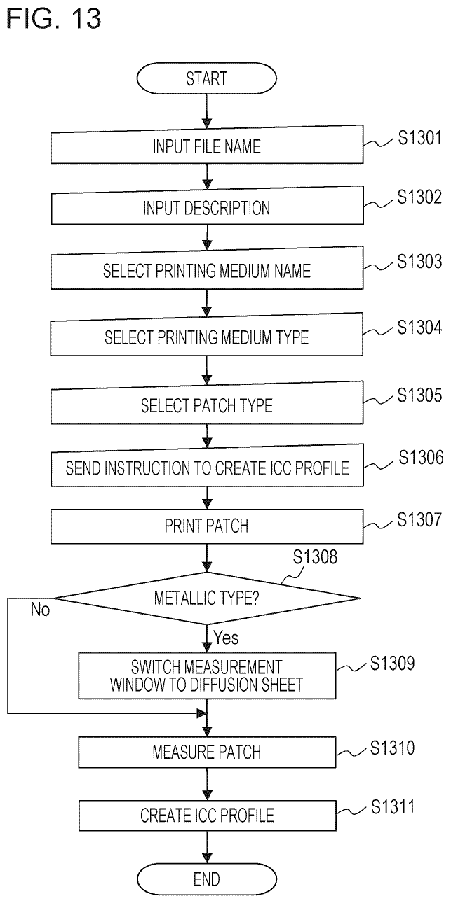

FIG. 13 is a flowchart of the ICC profile creation flow for one or more embodiments. In step S1301, the file name of the ICC profile to be created is input into the file name edit box 1201. In step S1302, a description is input into in the description edit box 1202. In step S1303, the name of the printing medium for which the ICC profile is to be created is selected from the printing medium name list box 1203. In step S1304, the type of printing medium for which the ICC profile is to be created is selected from the printing medium type list box 1204. In step S1305, the patch type to be used for ICC profile creation is selected from the patch type list box 1205. In step S1306, in a case where a Run button 1206 illustrated in FIG. 12A is pressed, ICC profile creation is initiated.

In step S1307, the patch selected in step S1305 is printed using the printing unit 301. The printed patch is conveyed to the measurement unit 304. In step S1308, it is determined whether the printing medium type selected in step S1304 is a metallic type. In a case where the metallic type is selected, the processing proceeds to step S1309. In a case where the metallic type is not selected, the processing proceeds to step S1310.

In step S1309, as illustrated in FIG. 11B, the diffusion sheet is placed in the measurement window of the pressing mechanism 1102 on the downstream side of the printing medium and, thus, the position of the diffusion sheet is switched. Normally, the pressing mechanism 1102 is in a state illustrated in FIG. 11C. In a case where the metallic type is selected, the state of the pressing mechanism 1102 is switched to that illustrated in FIG. 11B. In step S1310, the color patch is measured in the manner described above. The obtained measurement data is sent into the work memory 402. In step S1311, an ICC profile is created by the arithmetic unit 404 using the measurement data in the work memory 402. The created ICC profile is stored in a predetermined folder in the mass storage unit 405.

### Characteristics and Experimental Result of One or More Embodiments of a Diffusion Sheet

The present inventors conducted experiments using the following eight types of diffusion sheets:
(1) clear film (transparent film),
(2) one-ply tracing paper,
(3) two-ply tracing paper,
(4) one-ply translucent film,
(5) two-ply translucent film,
(6) three-ply translucent film,
(7) four-ply translucent film, and
(8) five-ply translucent film.

Step 1: Color patches were printed to create an ICC profile using silver metallic paper as a printing medium. Then, measurement values were obtained for each of the above-described eight types of diffusion sheets to create the ICC profile. The color patches include patches for a non-printing area (described below) and single-color patches of C, M, Y, and Bk. A single-color patch refers to a color patch printed using only one type of ink, rather than a combination of a plurality of types of ink. The single-color patches include single-color patches with a plurality of input values, including 100% input value. To measure a color patch, for example, one of the above-described eight diffusion sheets was placed on a silver metallic paper, and measurement was conducted using a measuring instrument with 45/0 optical geometry, which measured diffuse light in a specific direction.

Step 2: A spot color library was created by measurement values obtained by measuring an eight-color chart sampled from commercially available metallic sample color chart using each of the above-described eight types of diffusion sheets.

Step 3: Using each of the created ICC profiles and the corresponding spot color library, the color patches of the eight-sample color chart were color-converted, and the color conversion results of the eight different diffusion sheets were printed.

Step 4: To check the matching accuracy, measurement values were obtained using an integrating sphere measuring instrument (SCI mode including the specularly reflected light), which was considered to have a high correlation with the color perception in humans. The metallic sample color chart and each of the color patches printed in step 3 were measured using the integrating sphere measuring instrument, and the color difference was calculated.

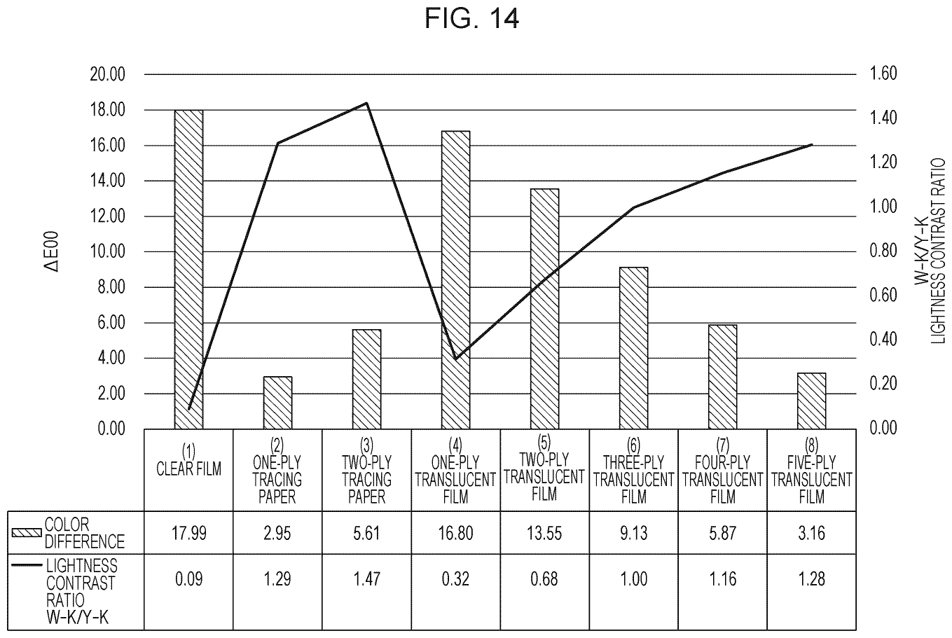

FIG. 14 is a graph illustrating the results of the above-described experiment. The bar graph illustrates the average ΔE00 of the color matching color difference for each of the diffusion sheets. Also illustrated is the lightness contrast ratio (W−K100/Y100−K100) in a case where the following three patches (W, K100, Y100) are used among the measurement values obtained using the diffusion sheets in step 1:

$$W : ( C , M , Y , K ) = ( 0 , 0 , 0 , 0 ) ,$$

$$K 100 : ( C , M , Y , K ) = ( 0 , 0 , 0 , 100 \% ) , and$$

$$Y 100 : ( C , M , Y , K ) = ( 0 , 0 , 100 \% , 0 ) .$$

W represents a patch of non-printing area. K100 represents one of the black single-color patches in a case where the input value K=100%. Similarly, Y100 represents one of the yellow single-color patches in a case where Y=100%. In the present experiment, a yellow single-color patch in a case where input value Y=100% was used, but it is not limited to an input value Y=100%, as long as the amount of ink covers the printing medium to make the surface invisible.

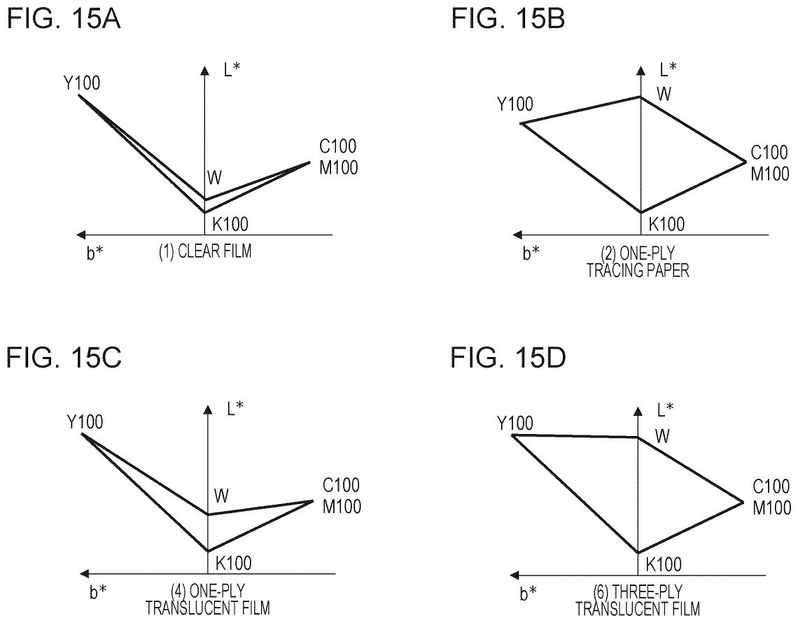

FIGS. 15A to 15D are schematic illustrations of the distributions of measurement values for “(1) clear film”, “(2) one-ply tracing paper”, “(4) one-ply translucent film,” and “(6) three-ply translucent film, respectively, for one or more embodiments.

The lightness contrast ratio of “(1) clear film” is 0.09, and the degree of light diffusion of the diffusion sheet is low. Therefore, it may be seen that the lightness of the patch W in the non-printing area of the silver metallic paper is measured to be low due to the large reflection component in the specularly reflected direction.

“(4) one-play translucent film” has a lightness contrast ratio of 0.32. The one-ply translucent film is more translucent than the clear film and has a higher degree of light diffusion than the clear film. Therefore, the lightness of patch W is measured somewhat higher but is a lower lightness than that of the patch Y100.

“(6) three-ply translucent film” has a lightness contrast ratio of 1.00, and the degree of light diffusion is higher than that of one-ply translucent film. Therefore, the lightness of the patch W is almost the same as that of the patch Y100.

“(2) one-ply tracing paper” has a lightness contrast ratio of 1.29 and has a high degree of light diffusion. The lightness of the patch W is higher than that of the patch Y100.

According to the matching color difference data and the lightness contrast ratio data illustrated in FIG. 14, the diffusion sheets with low matching accuracy have a lightness contrast ratio less than 1.0. This is because if the lightness contrast ratio is less than 1.0, color discrimination in the lightness direction may not be made, and colors of the same chromaticity at different lightness levels may not be distinguished. However, a diffusion sheet with a lightness contrast ratio greater than 1.0 tends to have high matching accuracy. A lightness contrast ratio greater than 1.0 means that the lightness of the patch W, which is a non-printing area of metallic paper, is higher than that of the patch Y100.

In the experiment, ICC profile creation was also attempted by measuring color patches printed on a silver metallic paper using a measuring instrument with 45/0 optical geometry without using a diffusion sheet. However, an ICC profile was unable to be created because the measurement data of the patch W in the non-printing area of the metallic paper was lower than the lightness of the patch K100.

As described above, an ICC profile, one of the print conditions for printing on metallic paper for one or more embodiments, was created using a measuring instrument with a 45/0 optical geometry that can measure diffuse light in a specific direction.

As mentioned above, a measuring instrument that measures diffuse light in a specific direction (for example, a measuring instrument with 0/45 or 45/0 optical geometry that may be used in commercial industrial printing) may not accurately measure a color patch printed on metallic paper with specular reflection. In contrast, integrating sphere measuring instruments and multi-angle measuring instruments can be used, but these measuring instruments are very expensive.

In addition, in some cases, an ICC profile may not be created depending on the correspondence between the device value of the measurement data and the measurement value. If the correspondence is different from normal correspondence (for example, the lightness of a non-printing area of a printing medium having no image printed thereon is lower than the lightness of any color in a printing area having an image printed thereon), an ICC profile may not be created. Even if an ICC profile can be created, the color matching accuracy may be low since the measurement is inaccurate.

In contrast, according to one or more embodiments, color matching may be accomplished by measuring both a metallic sample color chart which is a target value of color matching and the color patch on the metallic paper by using the same diffusion sheet. Furthermore, the matching accuracy may be increased by using a diffusion sheet that allows the lightness of the non-printing area of metallic paper to be measured higher than the lightness of a yellow single-color patch.

While at least one embodiment has been described with reference to the example in which the diffusion sheet is attached to the measurement window of the pressing mechanism, the at least one embodiment is not limited thereto. The diffusion sheet may be automatically attached to the aperture portion of a measuring instrument in a case where metallic paper is measured.

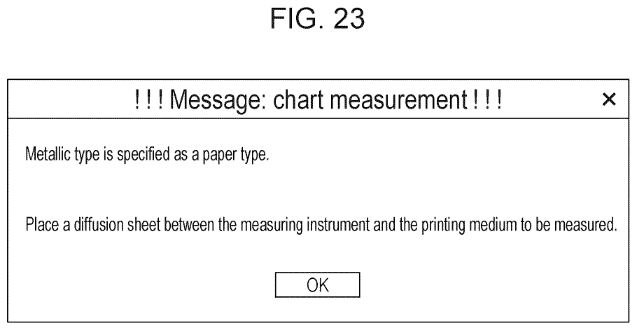

One or more embodiments of the present disclosure may use or may prefer measurement using a diffusion sheet and are not limited to a technique of attaching a diffusion sheet to the measurement window. For example, in a case where metallic paper is measured, a user may place a diffusion sheet between a measuring instrument and a printing medium to be measured. In this case, as illustrated in FIG. 23, the user is notified via the UI unit 401 to place the diffusion sheet between the metallic paper and the measuring instrument. In a case where the user presses an OK button, it is determined that information indicating that the diffusion sheet has been placed is input and, thus, the measurement is started. This enables an apparatus not including a diffusion sheet to perform the measurement using a diffusion sheet.

In a case where the resultant measurement value differs significantly from the expected value, the user may be notified. For example, a message indicating that the diffusion sheet is not in place and that the measurement has not been conducted correctly may be sent to the user.

### One or More Additional Embodiments

At least one embodiment of the above-described embodiments has been described with reference to the case in which the same diffusion sheet is used for both the measurement of a sample color chart and the measurement of color patches on metallic paper, which is one of the printing media. One or more additional embodiments are described with reference to use of different diffusion sheets. According to at least one embodiment, a configuration that allows a plurality of types of diffusion sheets to be placed between a measuring instrument and a printing medium to be measured is provided.

### Characteristics of Diffusion Sheet and Result of Experiment for One or More Embodiments

The five diffusion sheets (listed below) that had high matching accuracy in the experiment described in at least one of the above-described embodiments were selected, and the matching accuracy was checked while changing a combination of measurement of color sample using a first diffusion sheet and measurement of a color patch using a second diffusion sheet. The method for checking the matching accuracy was the same as in the above-described experiment.

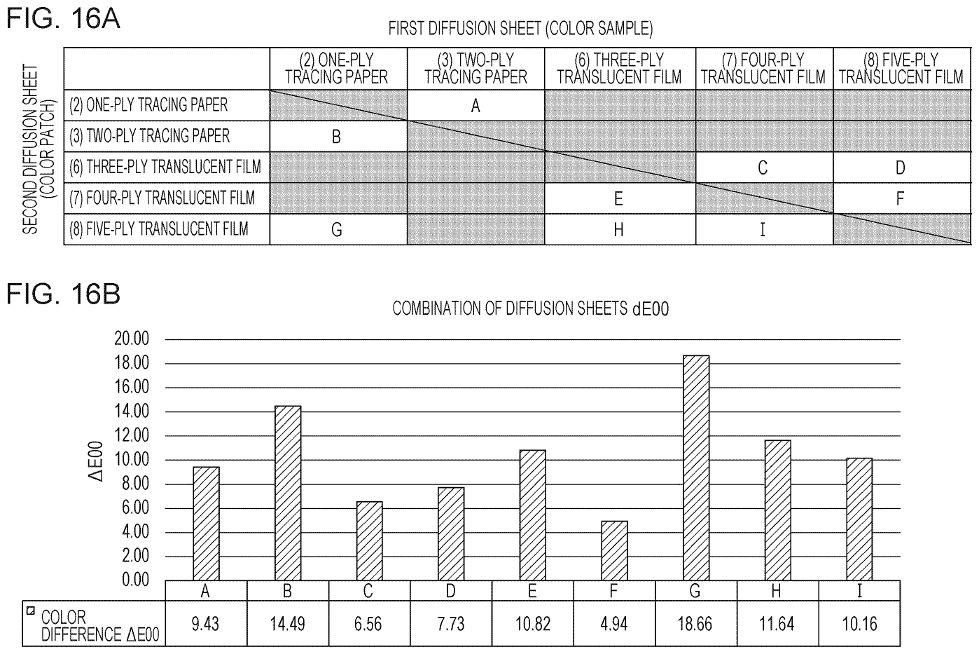

FIG. 16A illustrates the combinations that were checked:
(2) one-ply tracing paper,
(3) two-ply tracing paper,
(6) three-ply translucent film,
(7) four-ply translucent film, and
(8) five-ply translucent film.

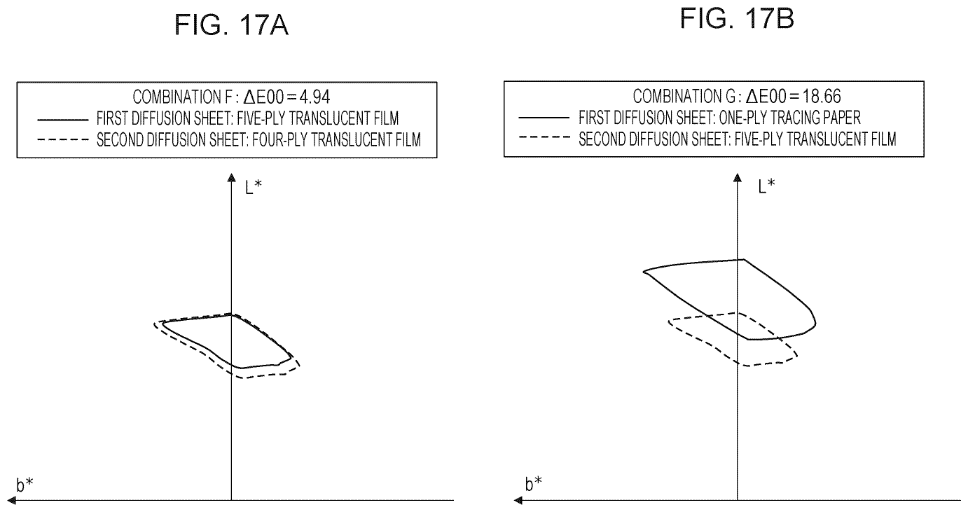

FIG. 16B illustrates the average color differences. The combination that provided the highest matching accuracy was a combination F in which the first diffusion sheet was “(8) five-ply translucent film”, and the second diffusion sheet was “(7) four-ply translucent film”. FIG. 17A illustrates overlap of the color gamuts projected onto the L*-b* plane in the CIE-L*a*b* space in a case where the color patches on the metallic paper was measured using each of the diffusion sheets. It may be seen that the color gamuts in a case where the first and second diffusion sheets are used are substantially the same and that the overlapping area is wide. The combination that provided the lowest matching accuracy was a combination G in which first diffusion sheet was “(2) one-ply tracing paper”, and the second diffusion sheet was “(8) five-ply translucent film”. FIG. 17B illustrates overlap of the color gamuts at this time, and it may be seen that there is very little overlap between the color gamuts of the first and second diffusion sheets.

As may be seen from the above-described experiment, color matching may be achieved even in a case where the first diffusion sheet and the second diffusion sheet are of different types. Furthermore, it may be seen that the matching accuracy increases in a case where the color gamuts of the first diffusion sheet and the second diffusion sheet overlap in a wide area.

As described above, color matching may be achieved even in a case where the diffusion sheet used to measure a color sample and the diffusion sheet used to measure a color patch on metallic paper are of different types.

### One or More Further Embodiments

One or more of above-described embodiments have been described with reference to the color conversion flow using a spot color library. According to one or more embodiments, the flow of a spot color adjustment function is described. The spot color adjustment is a function that is performed in a case where the user is not satisfied with the color matching between the color sample and the color that is designated as a spot color and that is output through the color conversion flow described in one or more of the aforementioned embodiments.

### Spot Color Adjustment Flow for One or More Further Embodiments

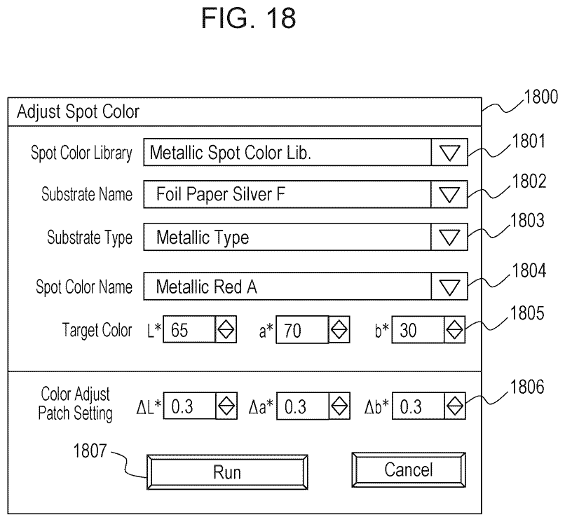

FIG. 18 illustrates a spot color adjustment dialog 1800. The image processing apparatus 307 has a function to adjust the spot color for each of printing media. In a case where the spot color adjustment function is activated in the UI unit 401, the spot color adjustment dialog 1800 illustrated in FIG. 18 is activated.

A list box 1801 is used to select a spot color library to be adjusted. To adjust the spot color of metallic paper, a corresponding spot color library dedicated to metallic paper is selected.

A list box 1802 is used to select a printing medium for which the spot color is to be adjusted. The printing media that have already been registered are listed. To adjust a spot color of metallic paper, the corresponding metallic paper name is selected.

A list box 1803 is used to select the type of printing medium for which the spot color is to be adjusted. The options are “paper type”, “film type”, and “metallic type”. To adjust the spot color of metallic paper, “metallic type” is selected.

A combo box 1804 is used to set the name of the spot color to be adjusted. Spot colors registered in the selected spot color library are listed. One of the listed spot color names may be selected, or a spot color name may be directly input to create a new one.

A UI 1805 is used to specify the spot color target value in CIE L*a*b*. For an already registered spot color, the registered Lab value is displayed. The value is changed via the UI 1805 to set the spot color target value. For a newly added spot color name, the Lab value is not displayed, and the user need to input a Lab value.

A UI 1806 is a UI used to specify a step size for the color of the patch to be output in the spot color adjustment. In the spot color adjustment, 27 color patches are printed that have colors centered at a Lab value specified as the spot color target value using the UI 1805 and are located at the front, back, left, right, top, and bottom of the specified Lab value shifted by the set step size. Such a step size is specified in the UI 1806.

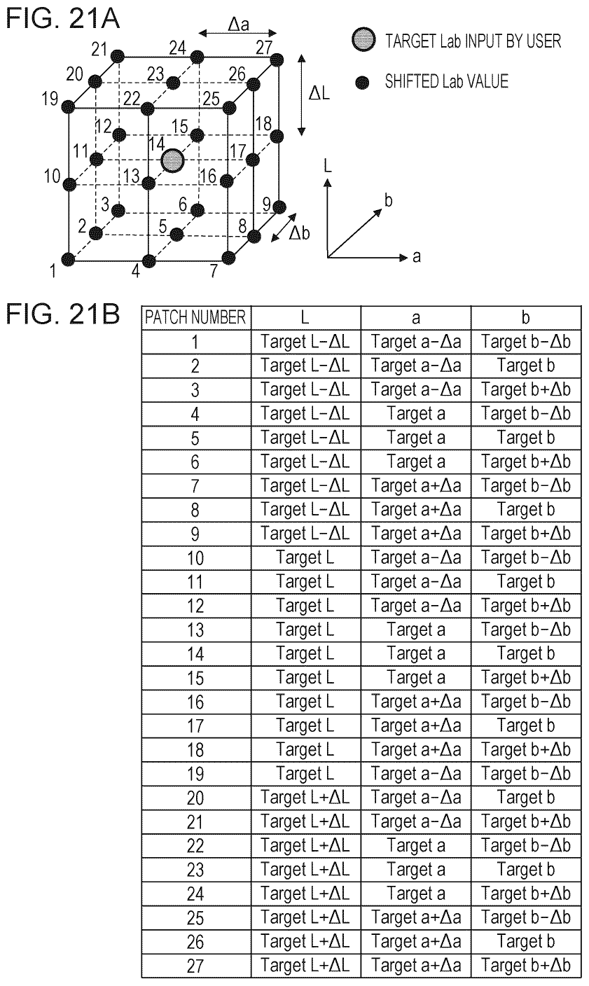

FIG. 21A illustrates the relationship between the target value and the patches that are around the target value and that have colors shifted by the step sizes, and FIG. 21B illustrates the Lab value of each of the patches.

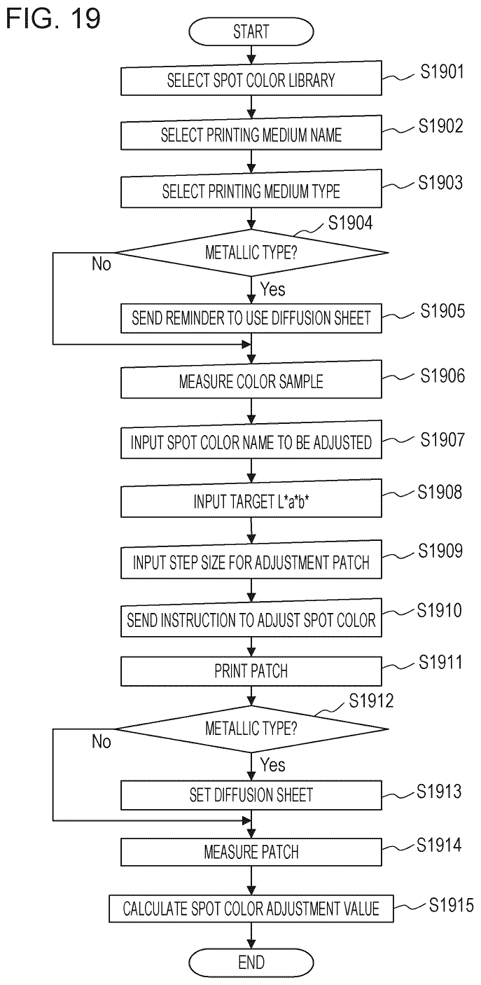

FIG. 19 is a flowchart of the spot color adjustment. In step S1901, a spot color library is selected using the list box 1801 of the spot color adjustment dialog 1800. Then, a metallic spot color library having the spot color to be adjusted registered therein is selected.

In step S1902, the printing medium for adjustment is selected. The name of the printing medium for adjustment is selected using the list box 1802 from among the registered printing media. In step S1903, the type of printing medium for adjustment is selected. An appropriate type is selected using the list box 1803 from among the printing medium types (a paper type, a film type, and a metallic type). In step S1904, it is determined whether the set printing medium type is a metallic type. In a case where the set printing medium type is a metallic type, the processing proceeds to step S1905. Otherwise, the processing proceeds to step S1906.

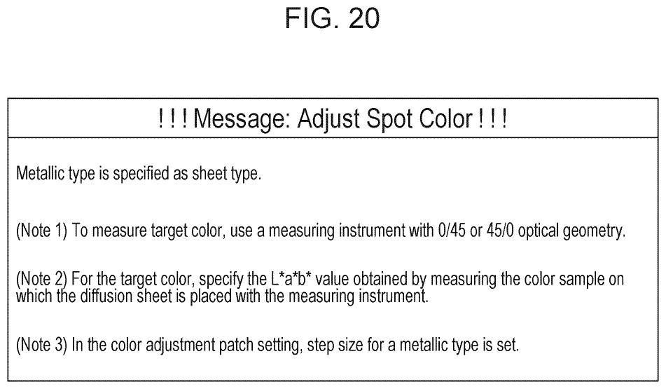

In step S1905, in a case where the metallic type is selected, the user is prompted to use a diffusion sheet in the measurement of the color sample. A message illustrated in FIG. 20 is displayed to prompt the user to use a measuring instrument with 0/45 or 45/0 optical geometry and to use a diffusion sheet in a case where measuring a color sample of the target color. In step S1906, the user manually measures the color sample of the spot color to be adjusted. The measurement is made using a measuring instrument owned by the user, not the measuring instrument inside of a device in the measurement unit 304, and the measurement result is memorized by the user as the Lab value of the color sample. In a case where a metallic type is selected, the user places the diffusion sheet on top of the color sample and measures the color sample. The diffusion sheet is provided in advance to the user as an accessory of the printing apparatus. If the target Lab value of the spot color to be adjusted is predetermined, step S1906 need not be performed.

In step S1907, the name of the spot color to be adjusted is input.

In a case where the spot color is one of the spot colors already registered via the combo box 1804, the spot color is selected from the list. In a case where the spot color is a newly registered spot color to be adjusted, the name of the spot color is input into the combo box 1804. In step S1908, the target Lab value of the spot color to be adjusted is input. The Lab value measured in step S1906 is input into the UI (the target color) 1805. In step S1909, the step size for a spot color adjustment patch is specified. A predetermined value is set as the default value in a case where the printing medium type is a paper type or film type. For example, ΔL=1, Δa*=1, and Δb*=1. The user can adjust each of the step sizes. In a case where the printing medium type is a metallic type, the data ranges in the lightness and saturation directions when the color patches are measured are less than when no diffusion sheet is used, because the measurement is made using a diffusion sheet.

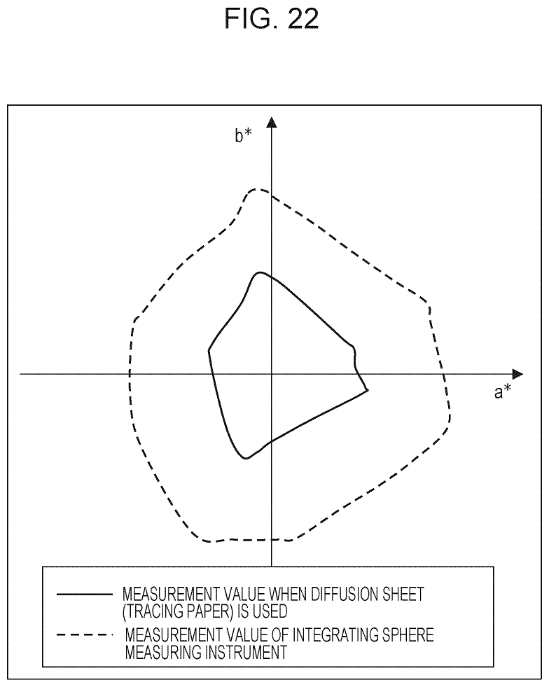

FIG. 22 illustrates the color reproduction of a color patch printed on silver metallic paper, one of the printing media, projected onto the a*-b* plane of CIE-L*a*b*. The measurement value measured by using a measuring instrument with 45/0 optical geometry and “(2) one-ply tracing paper” as the diffusion sheet and the measurement value obtained by using an integrating sphere measuring instrument are illustrated in FIG. 22. As may be seen from FIG. 22, the color gamut is decreased in a case where a diffusion sheet is used.

As described above, in the case where the difference in color gamut is large, if the same adjustment patch step size as that of a paper type or a film type is used, the adjustment patch step size for the color gamut of the diffusion sheet is relatively increased. Therefore, in the case of metallic paper, the interval between spot color adjustment patches actually printed is greater than the specified step size, making adjustment to the target color difficult. Therefore, in a case where the metallic type is specified as the printing medium type, the step size in step S1909 is reduced based on the size of the color gamut in a case where the diffusion sheet is used. For example, for the standard-sized color gamut of a paper type, let ΔL_p, Δa_p, and Δb_p be the differences between the maximum and minimum of L*, a*, and b*, respectively. Similarly, in color reproduction using a diffusion sheet for metallic paper, let ΔL_m, Δa_m, and Δb_m be the differences between the maximum and minimum of L*, a*, and b*, respectively. Then, a ratio S of decreasing the step size for the metallic type is calculated as follows:

$$S = ( ΔL\_m / ΔL\_p + Δa\_m / Δa\_p + Δb\_m / Δb\_p ) / 3.$$

In this case, the color gamut of the metallic type may be calculated by using the data in the A2B1 tag of the ICC profile associated with the printing medium name in the list box 1802.

For example, in a case where the calculated ratio S of decreasing the step size is 0.4, the following values are set as default values in the UI 1806 when a metallic type is specified:

$$Δ L = 1. \times 0.4 = 0.4 ,$$

$$Δ a = 1. \times 0.4 = 0.4 , and$$

$$Δ b = 1. \times 0.4 = 0.4 .$$

In a case where the metallic type is selected using the list box 1803 (printing medium type), the default values of the patch adjustment step size in the UI 1806 are also updated. To notify the user that the default values have been changed, the message in FIG. 20 also includes information indicating that the color adjustment step size has been updated.

In step S1910, the user provides an instruction to perform spot color adjustment. In a case where a Run button 1807 is pressed by the user, a spot color adjustment process is initiated. In step S1911, the spot color adjustment patch is printed. Image data and parameters for printing the color patch defined in FIG. 21B are generated, and the color patch is printed by the printing unit 301. The printed patch is conveyed to the measurement unit 304. In step S1912, it is determined whether the printing medium type selected in step S1903 is a metallic type. If the printing medium type is a metallic type, the processing proceeds to step S1913. If the printing medium type is not a metallic type, the processing proceeds to step S1914. In step S1913, the position of the measurement window is switched to that illustrated in FIG. 11B, so that the diffusion sheet is placed in the measurement window on the downstream side of the printing medium in the pressing mechanism 1102. In step S1914, the color patch is measured. The measurement data is sent to the work memory 402. In step S1915, the spot color adjustment value is calculated. The color patch having a Lab value closest to the target Lab value set in step S1908 is searched for among the measurement values on the work memory 402, and the device CMYK value used when the color patch was output is determined as the spot color adjustment value to be adjusted. The above is the spot color adjustment flow.

In a case where the user inputs target Lab values for a spot color, the user is prompted to use a diffusion sheet in the measurement of a metallic color sample. As a result, the data range may be set to be the same as that of the ICC profile of the metallic paper. In addition, the matching accuracy of spot color adjustment may be increased by the same data range.

According to one or more embodiments of the present disclosure, the diffusion sheet converts a strong directional component of reflected light that metallic paper reflects into a diffuse component. As a result, even a measurement unit that measures diffuse light in a specific direction may measure a patch printed on metallic paper.

### One or More Other Embodiments

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-167675, filed Sep. 26, 2024, which is hereby incorporated by reference herein in its entirety.

What is claimed is:

1. An image processing apparatus comprising:
a measurement unit that operates to measure a diffuse light in a specific direction, wherein the measurement unit measures a patch printed on a metallic paper that serves as a printing medium to be measured in a state in which a diffusion sheet that converts a strong directional component of light into a diffuse component is disposed between the metallic paper and the measurement unit; and
a determination unit that operates to determine a correction value for printing an image on the metallic paper based on a color matching target value corresponding to the state and a measurement result of the patch measurement performed by the measurement unit.

2. The image processing apparatus according to claim 1, further comprising:
a printing unit that operates to print the patch on the metallic paper.

3. The image processing apparatus according to claim 1, further comprising:
a holding unit that operates to hold the color matching target value in advance.

4. The image processing apparatus according to claim 1, further comprising:
a switching unit that operates to switch between a measurement in which the diffusion sheet is disposed between the measurement unit and the printing medium to be measured and a measurement in which the diffusion sheet is not disposed between the measurement unit and the printing medium to be measured.

5. The image processing apparatus according to claim 1, wherein the measurement unit enables a first type or a second type of diffusion sheet as the diffusion sheet to be disposed in a switchable manner between the measurement unit and the printing medium to be measured,
wherein the color matching target value is obtained based on a measurement result obtained in a case where an object serving as a target is measured using the first type of diffusion sheet, and
wherein the patch is measured using the second type of diffusion sheet.

6. The image processing apparatus according to claim 5, wherein in a case where the metallic paper is measured using the second type of diffusion sheet, a lightness of a non-printing area where an image is not printed is higher than a lightness of a printing area where printing is performed using only yellow ink.

7. The image processing apparatus according to claim 5, wherein in a case where the metallic paper is measured using the first type of diffusion sheet, a lightness of a non-printing area where an image is not printed is higher than a lightness of a printing area where printing is performed using only yellow ink.

8. The image processing apparatus according to claim 5, wherein a degree of light diffusion of the first type of diffusion sheet and a degree of light diffusion of the second type of diffusion sheet are substantially the same.

9. The image processing apparatus according to claim 5, wherein a degree of light diffusion of the first type of diffusion sheet and a degree of light diffusion of the second type of diffusion sheet are the same.

10. The image processing apparatus according to claim 5, wherein the printing unit uses the measurement result of the object measured using the first type of diffusion sheet as a color matching target value and prints a plurality of adjustment patches each having a color shifted from the color matching target value to one of different adjacent colors by a predetermined step size, and
wherein the step size is adjusted based on measuring results of the patches.

11. The image processing apparatus according to claim 1, further comprising:
a notification unit that operates to notify a user of information indicating that the diffusion sheet is to be placed between the metallic paper and the measurement unit in a case where a patch printed on the metallic paper is measured using the measurement unit.

12. The image processing apparatus according to claim 11, wherein a measurement using the measurement unit is performed in response to an acquisition of information indicating that the diffusion sheet is placed.

13. The image processing apparatus according to claim 1, wherein the measurement unit is a measuring instrument with one of 0/45 optical geometry and 45/0 optical geometry.

14. A measurement device comprising:
a measurement unit that operates to measure a diffuse light in a specific direction;
a notification unit that operates to, in a case where measuring a patch printed on a metallic paper using the measurement unit, provide a notification indicating that a diffusion sheet that converts a strong directional component of light into a diffuse component is to be placed between the metallic paper and the measurement unit; and
an execution unit that operates to cause the measurement unit to perform a measurement in response to an acquisition of information indicating that the diffusion sheet is placed.

15. The measurement device according to claim 14, further comprising:
a determination unit that operates to determine a correction value for printing an image on the metallic paper based on a color matching target value corresponding to a state in which the diffusion sheet is placed and a measurement result of the patch measurement performed by the measurement unit.

16. An image processing method comprising:
measuring a patch printed on a metallic paper that serves as a printing medium to be measured using a measurement unit that measures a diffuse light in a specific direction in a state in which a diffusion sheet that converts a strong directional component of light into a diffuse component is disposed between the metallic paper and the measurement unit; and
determining a correction value for printing an image on the metallic paper based on a color matching target value corresponding to the state and a measurement result of the patch measurement performed by the measurement unit.

17. A measurement method comprising:
in a case where a patch printed on a metallic paper is measured using a measurement unit that measures a diffuse light in a specific direction, providing a notification indicating that a diffusion sheet that converts a strong directional component of light into a diffuse component is to be placed between the metallic paper and the measurement unit; and
causing the measurement unit to perform a measurement in response to an acquisition of information indicating that the diffusion sheet is placed.
